(19) United States
(12) Patent Application Publication
(10) Pub. No.: US 2026/0141566 A1
(43) Pub. Date: May 21, 2026

(54) METHOD, DEVICE, AND COMPUTER PROGRAM FOR IMPROVING TRANSMISSION AND/OR STORAGE OF POINT CLOUD DATA

(71) Applicant: CANON KABUSHIKI KAISHA, Tokyo (JP)

(72) Inventors: Hervé RUELLAN, RENNES (FR); Naël OUEDRAOGO, VAL D'ANAST (FR); Franck DENOUAL, SAINT DOMINEUC (FR); Frédéric MAZE, LANGAN (FR)

(21) Appl. No.: 19/119,326

(22) PCT Filed: Oct. 16, 2023
(86) PCT No.: PCT/EP2023/078698

§ 371 Date: Apr. 8, 2025

(30) Foreign Application Priority Data
Oct. 17, 2022 (GB) 2215333.2

(51) Int. Cl. G06T 9/00; G06V 10/25

(52) U.S. Cl. CPC G06T 9/001; G06V 10/25

(57) ABSTRACT

A method for encapsulating point cloud data into an ISOBMFF-based media file. After having obtained a plurality of subsets of the point cloud data, a plurality of input items are generated, each input item describing a subset of point cloud data of the plurality of subsets, and a derived item is generated, the derived item comprising descriptive data of a spatial composition of the plurality of input items, the derived item being associated with the plurality of input items by an item reference. Next, the plurality of input items, the item reference, and the derived item are encapsulated in the media file.

### FIELD OF THE INVENTION

The present invention relates to a method, a device, and a computer program for improving transmission and/or storage of point cloud data, for example by defining a volumetric item as a grid of several volumetric items or by using a fusion of several volumetric items.

### BACKGROUND OF THE INVENTION

The Moving Picture Experts Group (MPEG) is standardizing the compression and storage of point cloud data (also called volumetric media data) information. Point cloud information consists in sets of 3D points with associated attribute information such as color, reflectance, and frame index.

On the first hand, MPEG-I Part-9 (ISO/IEC 23090-9) specifies Geometry-based Point Cloud Compression (G-PCC) and specifies a bit-stream syntax for point cloud information. According to MPEG-I Part-9, a point cloud is an unordered list of points comprising geometry information, optional attributes, and associated metadata. Geometry information describes the location of the points in a three-dimensional Cartesian coordinate system. Attributes are typed properties of each point, such as color or reflectance. Metadata are items of information used to interpret the geometry information and the attributes. The G-PCC compression specification (MPEG-I Part-9) defines specific attributes like frame index attribute or frame number attribute, with a reserved attribute label value (3 to indicate a frame index and 4 to indicate a frame number attribute), being recalled that according to MPEG-I Part-9, a point cloud frame is a set of points at a particular time instance. A point cloud frame may be partitioned into one or more ordered subframes. Still in MPEG-I Part-9, a point cloud frame is indicated by a FrameCtr variable, possibly using a frame boundary marker data unit or parameters in some data unit header (a frame_ctr_Isb syntax element).

On the second hand, MPEG-I Part-18 (ISO/IEC 23090-18) specifies a media format, based on ISO/IEC 14496-12 (ISOBMFF), that makes it possible to store and to deliver geometry-based point cloud compression data. It is also supporting flexible extraction of geometry-based point cloud compression data at delivery and/or decoding time. According to MPEG-I Part-18, the point cloud frames are encapsulated in one or more G-PCC tracks, a sample in a G-PCC track corresponding to a single point cloud frame. Each sample comprises one or more G-PCC units which belong to the same presentation time. A G-PCC unit is one type-length-value (TLV) encapsulation structure containing one of SPS, GPS, APS, tile inventory, frame boundary marker, geometry data unit, and attribute data units. The syntax of TLV encapsulation structure is defined in Annex B of ISO/IEC 23090-9.

Closely related to these standards, MPEG-I Part-5 (ISO/IEC 23090-7) specifies Visual volumetric video-based coding (V3C) and Video-based Point Cloud Compression (V-PCC). It specifies a generic mechanism for coding visual volumetric frames by converting the 3D volumetric information into a collection of 2D images and associated data. In addition, it specifies an application of this generic mechanism targeting point cloud representations of visual volumetric frames. MPEG-I Part-10 (ISO/IEC 23090-10) specifies a media format for storing and delivering visual volumetric video-based coding data in files based on ISO/IEC 14496-12 (ISOBMFF).

Both MPEG-I Part-18 and MPEG-I Part-10 allow storing timed or non-timed data. Timed data are stored using one or more tracks as defined by ISOBMFF. Non-timed data are stored using one or more items as defined by ISOBMFF.

While the ISO Base Media file format has proven to be efficient to encapsulate point cloud data, there is a need to improve encapsulation efficiency, for example to improve efficiency of coding the point cloud data to be encapsulated and/or to improve efficiency of decoding the encapsulated point cloud data.

### SUMMARY OF THE INVENTION

The present invention has been devised to address one or more of the foregoing concerns. It describes derived items that can be used to combine 3D items, for example using a regular grid or by specifying the location of each 3D item, making it possible, in particular, to encode and/or decode point cloud data independently, for example in parallel.

According to a first aspect of the invention, there is provided a method of encapsulating point cloud data into an ISOBMFF-based media file, the method comprising:
obtaining a plurality of subsets of the point cloud data;
generating a plurality of input items, each input item describing a subset of point cloud data of the plurality of subsets;
generating a derived item, the derived item comprising descriptive data of a spatial composition of the plurality of input items, the derived item being associated with the plurality of input items by an item reference;
encapsulating the plurality of input items, the item reference, and the derived item in the media file.

Accordingly, the method of the invention makes it possible to improve the processing efficiency of processing the point cloud data, for example of encoding the point cloud data, by enabling independent processing of subsets of point cloud data.

According to some embodiments, the descriptive data further comprise an indicator indicating whether point clouds corresponding to the point cloud data of each subset of point cloud data use a same reference frame.

According to some embodiments, the descriptive data further comprise an indicator indicating whether bounding boxes of point clouds corresponding to the point cloud data described by each of at least two input items of the plurality of input items overlap.

According to some embodiments, at least one indicator is associated with at least one input item of the plurality of input items, the at least one indicator indicating that the bounding box corresponding to the at least one input item overlap a bounding box associated with another input item of the plurality of input items.

According to some embodiments, the descriptive data further comprise an indicator for describing a three-dimensional array of cells, each input item of the plurality of input items corresponding to one of the cells.

According to some embodiments, the descriptive data further comprise an indicator indicating an order of the plurality of input items in the three-dimensional array of cells.

According to some embodiments, the descriptive data further comprise an indicator for describing a size of at least one of the cells.

According to some embodiments, the size of the cells is determined as a function of bounding boxes of point clouds corresponding to the point cloud data described by each of the plurality of input items.

According to some embodiments, the descriptive data further comprise an indicator indicating that at least one of the cells does not comprise any point defined in the point cloud data.

According to some embodiments, at least one item property is associated with at least one of the input item and/or the derived item for describing at least one spatial operation to be performed on points defined in the point cloud data.

According to some embodiments, the derived item comprises at least one indicator for describing at least one spatial operation to be performed on points defined in the point cloud data.

According to some embodiments, the method further comprises obtaining the point cloud data and splitting the obtained point cloud data as the plurality of subsets of the point cloud data.

According to a second aspect of the invention, there is provided a method for parsing an ISOBMFF-based media file encapsulating point cloud data, the method comprising:
obtaining a derived item from the media file, the derived item comprising descriptive data of a spatial composition of a plurality of input items, the derived item being associated with the plurality of input items by an item reference;
obtaining, from the media file, the plurality of input items as a function of the item reference, each input item describing a subset of point cloud data of a plurality of subsets;
obtaining, from the media file, the plurality of subsets of the point cloud data as a function of the plurality of input items; and
generating the point cloud data as a function of the descriptive data, the point cloud data comprising the point cloud data of the plurality of subsets.

Accordingly, the method of the invention makes it possible to improve the processing efficiency of processing the point cloud data, for example of decoding the point cloud data, by enabling independent processing of subsets of point cloud data.

According to some embodiments, the method further comprises determining, as a function of an indicator of the descriptive data, whether point clouds corresponding to the point cloud data of each subset of point cloud data use a same reference frame.

According to some embodiments, the method further comprises determining, as a function of an indicator of the descriptive data, whether bounding boxes of point clouds corresponding to the point cloud data described by each of at least two input items of the plurality of input items overlap.

According to some embodiments, at least one indicator is associated with at least one input item of the plurality of input items, the at least one indicator indicating that the bounding box corresponding to the at least one input item overlap a bounding box associated with another input item of the plurality of input items.

According to some embodiments, the method further comprises determining, as a function of an indicator of the descriptive data, a three-dimensional array of cells, each input item of the plurality of input items corresponding to one of the cells.

According to some embodiments, the method further comprises determining, as a function of an indicator of the descriptive data, an order of the plurality of input items in the three-dimensional array of cells.

According to some embodiments, the method further comprises determining, as a function of an indicator of the descriptive data, a size of at least one of the cells.

According to some embodiments, the method further comprises determining, as a function of an indicator of the descriptive data, that at least one of the cells does not comprise any point defined in the point cloud data.

According to some embodiments, the method further comprises applying, as a function of at least one item property associated with at least one of the input item and/or the derived item, a spatial operation to points defined in the point cloud data.

According to some embodiments, the method further comprises applying, as a function of at least one indicator of the derived item, at least one spatial operation to be performed on points defined in the point cloud data.

According to other aspects of the invention, there is provided a processing device comprising a processing unit configured for carrying out each step of the methods described above. The other aspects of the present disclosure have optional features and advantages similar to the first and second above-mentioned aspects.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer-readable code for provision to a programmable apparatus on any suitable carrier medium. A tangible carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIGS. 1a and 1b illustrate an example of steps and of file structure for storing and/or transmitting point cloud data (or 3D data) and for accessing, for example displaying, the stored and/or transmitted point cloud data (or a portion of the stored and/or transmitted point cloud data), according to some embodiments of the invention;

FIG. 2 illustrates an example of splitting a 3D volume associated with point cloud data into a plurality of 3D sub-volumes according to a 3D grid;

FIG. 3 illustrates an example of steps for storing or transmitting point cloud data as a grid of input G-PCC items, according to some embodiments of the invention;

FIG. 4 illustrates an example of steps for decoding and rendering point cloud data stored as a grid of input G-PCC items, according to some embodiments of the invention;

FIG. 5 illustrates an example of steps for storing and/or transmitting point cloud data as a 3D fusion item of input G-PCC items, according to some embodiments of the invention;

FIG. 6 illustrates an example of steps for decoding and rendering point cloud data stored as a 3D fusion of input G-PCC items, according to some embodiments of the invention; and

FIG. 7 is a schematic representation of an example of a data processing device configured to implement some embodiments of the present disclosure, in whole or in part.

### DETAILED DESCRIPTION OF THE INVENTION

A limitation of the specifications referred to above is that they do not address combining several items representing 3D data into one other item representing 3D data. Examples of such combinations include, but are not limited to, combining several items into a 3D grid, where each item represents the content of a cell from the grid, or combining several items into a 3D merged item where each item is located at a position specified by the 3D merge item. An advantage of defining an item representing 3D data as a combination of several items is that the combined items may be encoded or decoded independently in a parallel manner.

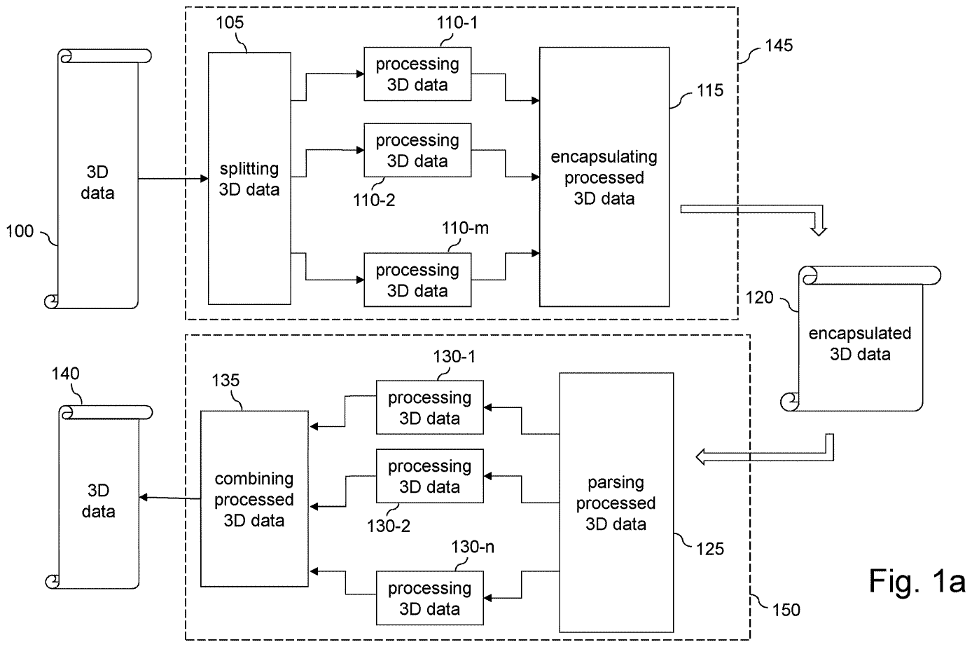

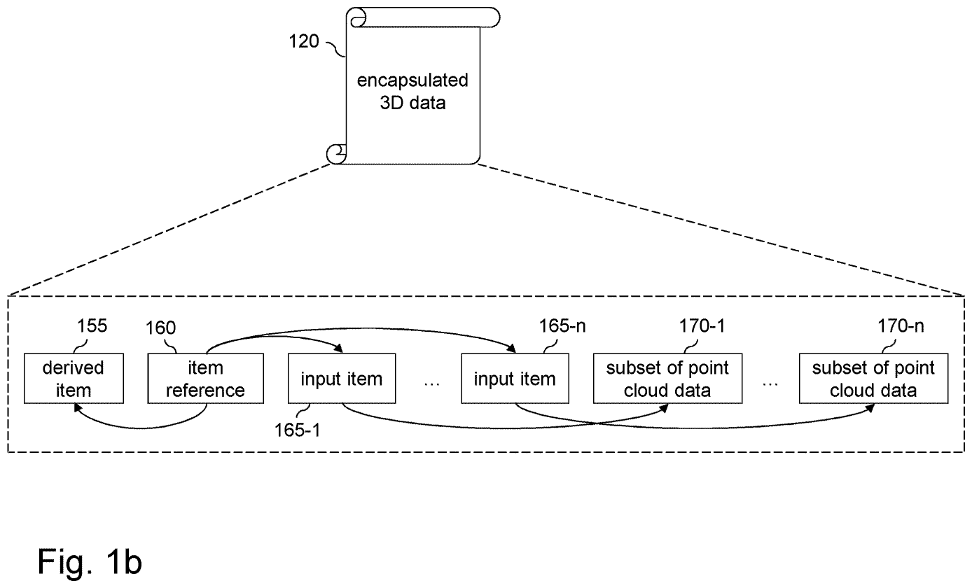

FIG. 1a illustrates an example of steps for storing and/or transmitting point cloud data (or 3D data) and for accessing, for example displaying, the stored and/or transmitted point cloud data (or a portion of the stored and/or transmitted point cloud data), according to some embodiments of the invention.

As illustrated, point cloud data 100 are split into a plurality of subsets of point cloud data (step 105) or obtained as a plurality of subsets of point cloud data, for example different spatial subsets or subsets obtained from different sensors or corresponding to different points of view, each of the subsets being processed in parallel (steps 110-1 to 110-m), for example to be encoded in parallel. For each point cloud data subset, the processed data are described in an input item that may be called point cloud item. A point cloud item describes point cloud data that may be encoded, for example with MPEG-I Part-5 or MPEG-I Part-9 and that may be called a V-PCC (or V3C) point cloud item or a G-PCC point cloud item respectively. When used as an input of a derivation or within a group of items, it may also be called an input point cloud, a V-PCC (or V3C) input item, or a G-PCC input item. When using only “input item” or “input point cloud” in the context of the invention, it means a point cloud item whatever its encoding format. The resulting set of input items, is then encapsulated (step 115) to generate an encapsulated data file 120 that may be stored locally or transmitted to a remote server to be stored and/or to be processed, for example to display the point cloud data (or a portion of the point cloud data). The encapsulated data file comprises the input items describing the processed point cloud data subsets, the processed point cloud data subsets, and a derived item that comprises descriptive data making it possible to combine the point cloud data of each subset. More generally, a derived item is an item defining operations to be performed on input items associated with the derived item via an item reference of type ‘dimg’. For example, such descriptive data may represent a spatial composition of the point cloud data described by the input items. In addition, the encapsulated file comprises an item reference to associate the derived item with the input items.

The encapsulated data file may be of the ISOBMF format.

To access the point cloud data (or a portion of the point cloud data) encapsulated in the encapsulated data file, the latter is parsed (step 125) to obtain the derived item. Using information from the derived item, the input items describing the subsets of processed point cloud data may be accessed, making it possible to access the point cloud data that may be processed in parallel (steps 130-1 to 130-n), for example to be decoded in parallel. The processed point cloud data are then combined as a function of information from the derived item (step 135) to generate a valid point cloud data 140. As another example, the point cloud data may be decoded and stored in a memory structure adapted to 3D rendering in parallel (steps 130-1 to 130-n) and then be combined by a 3D rendered (step 135) to generate a 3D rendering of the point cloud data.

It is not noted that steps 105, 110-1 to 110-m, and 115 may be carried out in a server 145 or in several servers (or processing devices). Likewise, steps 125, 130-1 to 130-n, and 135 may be carried out in a server 150, a client, or in several servers or processing devices.

FIG. 1b illustrates an example of a file structure for storing and/or transmitting point cloud data (or 3D data) and for accessing, for example displaying, the stored and/or transmitted point cloud data (or a portion of the stored and/or transmitted point cloud data), according to some embodiments of the invention.

As illustrated, encapsulated data file 120 comprises a derived item 155 (e.g. an item comprising in its body a GPCCGrid structure) that is identified in an item reference 160 (e.g. a SingleItemTypeReferenceBox of type ‘dimg’ in an ItemReferenceBox ‘iref’ as described below), the item reference also identifying a plurality of input items 165-1 to 165-n (e.g. input G-PCC items, V-PCC items, or V3C items) that describes subsets 170-1 to 170-n of point cloud data. Accordingly, a point cloud may be stored and/or transmitted as a plurality of subsets of point cloud data and may be rendered while making it possible to process the subsets of point cloud data in parallel.

For the sake of illustration, two use cases are described hereafter. According to the first use case, the point cloud data are divided into a plurality of spatial subsets according to a 3D grid and according to the second use case, the point cloud data are divided into a plurality of subsets depending on another criterion, for example the sensors used to acquire the point cloud data, that is to say according to a 3D fusion criterion.

### 3D Grid

According to a particular embodiment, a 3D volume associated with point cloud data is divided into a plurality of 3D sub-volumes, the point cloud data of each of these 3D sub-volumes being processed independently and being described into a specific item referred to as an input item.

It is noted that for the sake of illustration, the following description mainly focuses on point cloud data encoded as G-PCC streams according to MPEG-I Part-9 and stored as G-PCC items according to MPEG-I Part-18. However, it can be easily extended to point cloud data encoded as V-PCC streams according to MPEG-I Part 5 and stored according to MPEG-I Part 10, or more generally to any 3D content stored according to ISOBMFF.

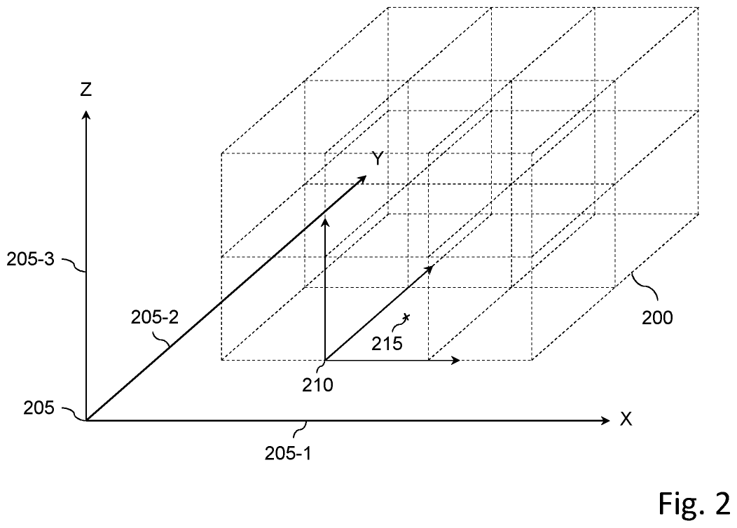

FIG. 2 illustrates an example of splitting a 3D volume associated with point cloud data into a plurality of 3D sub-volumes according to a 3D grid.

According to the illustrated example, the 3D grid 200 comprises 12 cells arranged in a 3×2×2 array. Naturally, the 3D volume associated with the point cloud data may be split differently, into the same or a different number of cells.

The coordinates of the points inside this 3D volume are defined as a function of a reference frame, for example reference frame 205 that is defined by 3 axes: X axis 205-1, Y axis 205-2, and Z axis 205-3. The origin of reference frame 205 may correspond to a corner of the grid cell or may be located elsewhere (as illustrated). Reference frame 205 defines a global reference frame shared by all the points in the 3D volume. Alternatively, the coordinates may be represented by three angles like (azimuth, elevation and tilt) or (yaw, pitch, roll).

In addition, a local reference frame may be used within each cell of the 3D grid for identifying points within this cell. For the sake of illustration, the origin of such a local reference frame may correspond to a corner of the cell, for example the one that is the closest to the origin of the global reference frame or the one with the smallest coordinates in the global reference frame. The axes of the local reference frame may be parallel to the axes of the global reference frame. An example of a local reference frame is illustrated with reference 210, that is associated with one cell of the 3D grid. Still for the sake of illustration, the location of point 215 may be defined using the global reference frame 205 or using the local reference frame 210.

According to a particular embodiment, a 3D grid G-PCC item may be represented as a derived point cloud item with an item_type having a specific value, for example the value ‘grd3’. This 3D grid may be used to combine one or more input G-PCC items in a grid. Thus, an item with item_type value of ‘grd3’ defines a derived point cloud item whose reconstructed point cloud is formed from one or more input point clouds in a given 3D grid order. The data associated with the derived point cloud item may specify some characteristics of the grid and may have the following structure:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(1) same_origin; | |
| unsigned int(1) morton_order; | |
| unsigned int(1) has_cell_size; | |
| unsigned int(5) reserved; | |
| if (has_cell_size == 1) { | |
| unsigned int(8) | precision; |
| Vector3 | cell_size (precision); |

}
}

wherein the version field signals the version of the structure and the flags field is a map of flags that may signal some options for the structure. version or flags should be equal to 0 if there is no version defined or flags defined respectively.

The width_minus_one, height_minus_one, and, depth_minus_one fields represent the number of cells in the grid respectively along the X, Y, and Z axis.

In this grid, the cell located at the 0-based indices iₓ, i_{y}, and i_{z} has coordinates extending from cₓ*iₓ to cₓ*(iₓ+1) along the X axis, from c_{y}*i_{y} to c_{y}*(i_{y}+1) along the Y axis, and from c_{z}*i_{z} to c_{z}*(i_{z}+1) along the Z axis, where cₓ, c_{y} and c_{z} are the sizes of a cell along the X, Y, and, Z axes.

The same_origin flag indicates whether the point cloud data associated with the input G-PCC items that are to be combined in the grid use the same reference frame. If the value of the same_origin flag is set to a first value, for example 1, all input G-PCC items are defined using the same reference frame or coordinate system, for example the global reference frame 205. In this case, the input G-PCC items may be combined in the grid without applying a translation or transformation to them to insert them into the grid. Otherwise, if the value of the same_origin flag is set to a second value, for example 0, each input G-PCC item is defined using its own reference frame, for example the local reference frame of the cell where the point cloud data of the input G-PCC item are located. In this latter case, a translation may be applied to the coordinates of a point of an input G-PCC item to compute its coordinates in a global reference frame associated with the grid in order to insert into the grid. This translation may be the following:

$${x}_{g} = {x}_{l} + {c}_{x} * {i}_{x}$$

$${y}_{g} = {y}_{l} + {c}_{y} * {i}_{y}$$

$${z}_{g} = {z}_{l} + {c}_{z} * {i}_{z}$$

wherein x_{g}, y_{g}, and z_{g} are the coordinates of the point in the global reference frame and xₗ, yₗ, and zₗ are the coordinates of the point in the local reference frame of the input G-PCC item. As described above, cₓ, c_{y}, and c_{z} are the sizes of a cell along the X, Y, and Z axes and iₓ, i_{y}, and i_{z} are the 0-based indices of the position of the input G-PCC item in the grid.

The translation defined above transforms the coordinates of a point expressed in the local reference frame of the input G-PCC item containing this point into coordinates expressed in the local reference frame of the grid's cell located at position (0, 0, 0), which may be used as a global reference frame for the grid. Naturally, another global reference frame could be used, for example by defining a translation from the local reference frame of the grid's cell located at position (0, 0, 0) to this other global reference frame through an item property associated with the 3D grid derived item. As another example, this translation may be specified inside the GPCCGrid structure as a 3D vector such as:

| aligned(8) class GPCCGrid { | |
|---|---|
| ... | |
| unsigned int(8) | origin_precision; |
| Vector3 | global_origin(origin_precision); |

...
}

where the origin_precision field specifies the precision used for encoding the position of the global origin and the global_origin field is a 3D vector representing the position of the global_origin, which may be represented using the Vector3 structure specified by MPEG-I Part-7 (ISO/IEC 23090-7). As a variant, the position of the origin of the local reference frame of the grid's cell located at position (0, 0, 0) in the global reference frame may be encoded.

Possibly, when the value of the same_origin flag is set to the second value (0 in the example above), an input G-PCC item may be centered inside its grid's cell, or aligned with one or more faces of its grid's cell.

Possibly, when the value of the same_origin flag is set to the first value (1 in the example above), the input G-PCC items may have a size smaller than the size of a grid's cell. The location of the whole grid may be determined from a bounding box specified in an item property associated with the 3D grid item. The location of the whole grid may be determined by finding for each axis the input G-PCC item that has the largest size along this axis and by determining the location along this axis of the grid's cell containing this input G-PCC item from the extent of this G-PCC item along this axis. For instance, the location along this axis of the grid's cell may be determined such as the input G-PCC item is centered inside the grid's cell along this axis, or such as the input G-PCC item is aligned with one of the border of the grid's cell along this axis. The location of the whole grid may also be specified inside the GPCCGrid structure as a 3D vector, using for example the following structure:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(1) same_origin; | |
| unsigned int(1) morton_order; | |
| unsigned int(1) has_cell_size; | |
| unsigned int(5) reserved; | |
| if (has_cell_size == 1) { | |
| unsigned int(8) | precision; |
| Vector3 | cell_size(precision); |
| } | |
| if (same_origin == 1) { | |
| unsigned int(8) | grid_precision; |
| Vector3 | grid_position(precision); |

}
}

where the grid_precision field specifies the precision used for encoding the position of the grid and the grid_position field is a 3D vector representing the position of the corner of the grid with the smallest coordinates.

The same_origin field highlights a difference between 2D images and 3D point clouds. In a 2D image, the coordinates of a pixel are specified implicitly: the pixels are signaled from the top-left to the bottom right according to a row-first scan order. In a 3D point cloud, the coordinates of a point are specified explicitly by encoding its position as x, y, z. This difference lies in the nature of the pixels in 2D images, each pixel corresponding to a square or rectangular area associated with items of information (usually color and possibly transparency). In a 3D point cloud, a point has no volume and is therefore pointwise. In addition, a 3D point cloud is usually sparse: there are many empty areas in a 3D point cloud. Therefore, for achieving a precise and efficient encoding of a 3D point cloud, the position of a point or of a set of points may be specified explicitly. As a result, for a 2D image, the pixel coordinates always start at (0, 0) for the top-left pixel and end at (width, height) for the bottom-right pixel, while for a 3D point cloud the point coordinates may use any reference frame.

In the GPCCGrid structure, the morton_order field indicates the ordering of the input G-PCC items. According to some embodiments, the input G-PCC items are signaled in a SingleItemTypeReferenceBox of type ‘dimg’ in an ItemReferenceBox ‘iref’. In this SingleItemTypeReferenceBox, the value of the from_item_ID field identifies the derived point cloud item. In these embodiments, the input G-PCC items may be retrieved by looking for the SingleItemTypeReferenceBox of type ‘dimg’ whose from_item_ID field value is the identifier associated with the 3D grid G-PCC item. The value of reference_count is preferably equal to (width_minus_one+1)*(depth_minus_one+1)*(height_minus_one+1). Still according to some embodiments, the value of to_item_ID field identifies the input G-PCC items. The SingleItemTypeReferenceBox may be referred to as the item reference.

If the value of the morton_order field is set to a first value, for example 0, the input G-PCC items are ordered in a line-scan order, by increasing X first, followed by increasing Y, then followed by increasing Z. In some variants, the line-scan order may arrange the axes differently. If the value of the morton_order field is set to a second value, for example 1, the input G-PCC items are ordered in a Morton order (or Z-scan order). The use of a Morton order makes it possible to better preserve the local characteristics of the data inside the grid: using the line-scan order, input G-PCC items corresponding to adjacent cells may be far apart, while using the Morton order, the G-PCC items are located closer.

The ordering of the input G-PCC items is the order in which they are listed in the to_item_ID field of the SingleItemTypeReferenceBox. Preferably, this is also the order in which their associated data are stored in a file or transmitted over a network.

According to some embodiments, the input G-PCC items have the same size. This size is the size of a cell in the grid. This size may be specified by an item property of one or more of the input G-PCC items, for example a bounding-box item property or a size item property. This size may be specified in the GPCCGrid structure. If the size is specified both in an item property of one or more of the input G-PCC items and in the GPCCGrid structure, the specified sizes are preferably all the same. If the value of the has_cell_size field of the GPCCGrid structure is set to a first value, for example 0, the size of a cell of the grid is not specified inside the GPCCGrid structure. In such a case, all the bounding boxes of the input point cloud shall have the same size, which is the cell's size. If the desired input point clouds are not of a consistent size, derived point cloud items (e.g. of type ‘iden’ representing the identity transformation) that scale or crop them, as needed to make them consistent, can be used; other specifications can, however, restrict whether derived point cloud items are permissible as input to the point cloud grid derived item.

If the value of the has_cell_size field of the GPCCGrid structure is set to a second value, for example 1, the size of a cell of the grid is specified inside the GPCCGrid structure by the cell_size field. The precision field specifies the precision used for encoding the size of a cell. The cell_size field is a 3D vector representing the size of a cell, which may be represented using the Vector3 structure specified by MPEG-I Part-7 (ISO/IEC 23090-7).

When removing an item that is marked as an input point cloud of a point cloud grid item, the content of the point cloud grid item might need to be rewritten.

Preferably, all the points from an input G-PCC item are located inside the boundaries of the grid's cell corresponding to its input G-PCC item. When the same_origin flag is set to a first value, for example 1, all the points from an input G-PCC item preferably have coordinates inside the boundaries of the grid's cell where the input G-PCC item is located. When the same_origin flag is set to a second value, for example 0, after applying the translation described above, all the points from an input G-PCC item preferably have coordinates inside the boundaries of the grid's cell where the input G-PCC item is located.

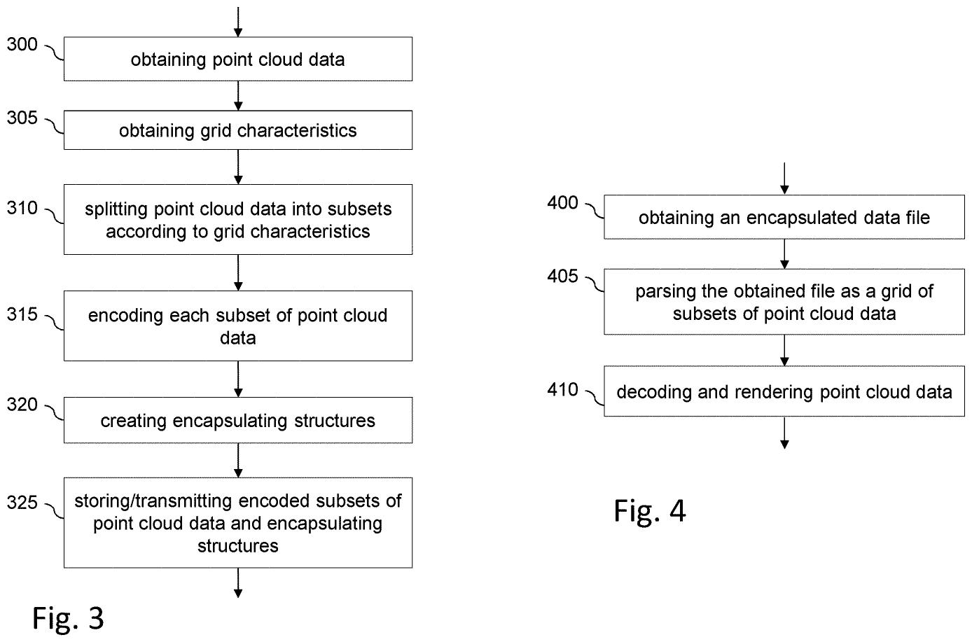

FIG. 3 illustrates an example of steps for storing or transmitting point cloud data as a grid of input G-PCC items, according to some embodiments of the invention.

As illustrated, a first step is directed to obtaining the point cloud data to store or to transmit (step 300). These point cloud data may be obtained directly from a sensor such as a LiDAR or may result from processing one or more point clouds acquired by one or several sensors. For example, several point clouds may be captured by a LiDAR, registered and transformed so that they use the same reference frame and then combined into a single point cloud.

Next, the target characteristics for the grid to be used are obtained (step 305). According to some embodiments, the size of each cell of the grid is obtained and using this cell size and the spatial size of the point cloud obtained at step 300, the number of cells in each dimension is computed. As a variant, the number of cells in each dimension may be obtained and the size of each cell may be computed using the spatial size of the point cloud.

In addition, the ordering of the input items in the grid may be obtained. As described above, this ordering may be, for example, a line-scan order or a Morton order. It is noted that a default ordering, for example a line-scan ordering, may be defined if no ordering is provided.

Furthermore, an indication for indicating whether the same origin is to be used for all the input G-PCC items may be obtained. Possibly, when using the same origin for all the input G-PCC items, a translation to be applied to all the input G-PCC items before encoding them may be obtained. According to some embodiments, a translation to be applied to the reconstructed grid may be obtained in the case according to which a same origin is not used for all the input G-PCC items.

It is observed that step 305 may be carried out before step 300 or simultaneously.

Next, the point cloud data obtained in step 300 are split into subsets of point cloud data (step 310), as a function of the cells determined according to the grid characteristics obtained in step 305. As a result, a point cloud corresponding to a subset of the point cloud obtained in step 300 is obtained for each of the cells of the grid or for some the cells of the grid since the grid may be sparse (i.e. it may comprise some cells without any point from the point cloud data).

Next, each of the subsets of point cloud data is encoded (step 315). According to some embodiments, this encoding step is carried out independently for each of the subsets of point cloud data, for example in parallel. Still according to some embodiments, the encoding step is based on the MPEG-I Part-9 specifications.

During this step, if the same origin is used for all the input G-PCC items, the translation possibly obtained at step 305 may be applied to each point of the point cloud data before it is encoded or during its encoding. If a same origin is not used for the input G-PCC items, the points of each subset of point cloud data may be translated as a function of the local reference frame associated with the corresponding cell of the grid before it is encoded or during the encoding.

Next, the structures for encapsulating the grid and the encoded point cloud data are created (step 320). For instance, a GPCCGrid structure as described above may be created for describing the grid and storing its characteristics. In addition, G-PCC items may be created for describing each subset of encoded point cloud data. Possibly, each subset of encoded point cloud data may be described either in a single G-PCC item or within several G-PCC items. As described above, a SingleItemTypeReferenceBox of type ‘dimg’ may be created for linking the input G-PCC items describing the subsets of encoded point cloud data with the item representing the grid (i.e. the derived item). The ordering of the input G-PCC items inside the SingleItemTypeReferenceBox may depend on the ordering obtained at step 305.

It is noted that step 320 (or some of its sub-steps) may be carried out in parallel to encoding step 315 or as a part of encoding step 315.

Next, the subsets of point cloud data encoded in step 315 and the encapsulating structures created in step 320, comprising the item reference establishing a link between the derived item and the input items (e.g. SingleItemTypeReferenceBox of type ‘dimg’), are stored in an encapsulated data file, for example an ISOBMFF file. Before being stored, the subsets of encoded point cloud data may be ordered according to the ordering obtained at step 305. Possibly, the ISOBMFF file is stored in a memory unit (for example a random access memory) or in a hard drive. Possibly, the ISOBMFF file is sent over a communication network.

It is observed that encoding point cloud data as a grid may advantageously increase the encoding speed of the point cloud data since several encoding operations may be carried out in parallel.

According to some embodiments, an identity derived point cloud item may be represented as an item with an item_type having a specific value, for example the value ‘iden’. This identity derived point cloud item may be used when it is desired to use transformative properties to derive a point cloud item. The derived point cloud item has no item body (i.e. no extents), and reference_count for the ‘dimg’ item reference of a ‘iden’ derived point cloud item is equal to 1.

According to some embodiments, the point cloud data are obtained in chunks in step 300 (and the chunks are not all obtained simultaneously). According to these embodiments, one or more chunks of the point cloud data are processed independently of the remaining chunks. The one or more chunks are split in several subsets of point cloud data in step 310. Next, for each subset of point cloud data, a test is carried out to determine whether the subset of point cloud data contains the whole data for its corresponding grid's cell or if some of the cell's data are missing. If a subset of point cloud data contains the whole data for its corresponding grid's cell, it may be encoded as described above in relation to step 315, next encapsulating structures may be created to signal it as described previously in relation to step 320, and this subset of encoded point cloud data and its encapsulating structures may be stored as described in relation to step 325.

Preferably, in these embodiments, the boundaries between the grid's cells are selected such that the boundaries between the chunks match the grid's boundaries. For example, if the point cloud data are obtained from a rotating LiDAR and each chunk corresponds to a quadrant of the volume captured by the rotating LiDAR, the limits corresponding to these quadrants may define the limits between the grid's cells.

Still according to some embodiments, the point cloud data to be stored as a grid of point cloud data are already split into subsets of point cloud data and each subset of point cloud data is already encoded.

In such embodiments, the subsets of encoded point cloud data are obtained in step 300 and the grid characteristics are obtained in step 305.

The size of each cell of the grid may be obtained from the spatial size of one of the subsets of encoded point cloud data obtained in step 300. Possibly, if the subsets of encoded point cloud data have different spatial sizes, the size of the cells of the grid may be defined as being the largest spatial size of the subsets of encoded point cloud data. For instance, the size of the cells along the X axis of the grid may be determined by identifying the largest spatial size of the subsets of encoded point cloud data along the X axis. The size along the Y axis and along the Z axis of the grid may be determined similarly. The spatial size of a subset of encoded point cloud data may be obtained from a bounding box associated with the subset of encoded point cloud data. It may be computed from the content of the encoded point cloud data.

Possibly, if the subsets of encoded point cloud data have different spatial sizes, the size of a cell of the grid may be determined as the smallest spatial size of the subsets of encoded point cloud data, as the average spatial size, or as the median spatial size.

Possibly, if the subsets of encoded point clouds have different spatial sizes, each point cloud may be centered inside its cell by applying a translation to it. This translation may be applied either by re-encoding the point cloud or by defining a transformative property associated with the input G-PCC item used to encapsulate the subset of point cloud data.

Possibly, if the spatial size of a subset of encoded point cloud data is larger than the size of a cell, it may be cropped to fit into the cell. This cropping may be carried out before or after applying translations to the points of the subset of encoded point cloud data.

The ordering of the input items may be obtained explicitly as described above. It may also be obtained implicitly, for example using the order according to which the subsets of encoded point cloud data are obtained in step 300.

The indication on whether the same origin is to be used for all the input G-PCC items may be obtained explicitly as described above. It may also be determined from the obtained subsets of encoded point cloud data. For instance, the minimum and the maximum coordinate values along each axis for each subset of encoded point cloud data are computed and if the minimum and maximum coordinate values are the same for all the encoded point clouds, it may be concluded that they do not have the same origin. Otherwise, it is determined they have the same origin. Still for the sake of illustration, the size along each axis for each subset of encoded point cloud data may be computed. If the difference between the largest minimum coordinate value along an axis for a subset of encoded point cloud data and the smallest minimum coordinate value along the same axis for another subset of encoded point cloud data is greater than or equal to the maximum size along the same axis for the subsets of encoded point cloud data, it may be concluded that that the point clouds have the same origin.

Possibly, a translation may be obtained as described above.

Possibly, the location of the points of each subset of encoded point cloud data inside the grid may be obtained explicitly. In this case, the indication on whether to use the same origin for the input G-PCC items may be obtained by comparing the coordinates used by points of subsets of encoded point cloud data located in adjacent cells. For instance, if the points of a first subset of encoded point cloud data are located at the index i along an axis and the points of a second subset of encoded point cloud data are located at the index i+1 along the same axis, it is concluded that the same origin is used for the different point clouds if the maximum coordinate value along this axis for the points of the first subset is lower than the minimum coordinate value along this axis for the points of the second subset.

Possibly, the location of points of each subset of encoded point cloud data inside the grid may be obtained implicitly when the input G-PCC items have the same origin. Using the size of a cell of the grid, the range of coordinates for each cell of the grid may be computed. Then, for the points of each subset of encoded point cloud data, the minimum and maximum coordinate value along each axis are computed. These minimum and maximum coordinate values may be used to obtain the position of the cell corresponding to these coordinates.

In this alternative, step 310 and step 315 are not carried out. Depending on how the subsets of encoded point cloud data are obtained in step 300, step 320 may be fully or partially carried out. If the encoded point cloud data are obtained as compressed streams, for example as specified by MPEG-I Part-9, input G-PCC items may be created for describing each subset of encoded point cloud data. If the subsets of encoded point cloud data are obtained as input G-PCC items, these items may be used directly. Other parts of step 320 may be carried out as described above.

In this alternative, step 325 is carried out as described above.

FIG. 4 illustrates an example of steps for decoding and rendering point cloud data stored as a grid of input G-PCC items, according to some embodiments of the invention.

As illustrated, a first step is directed to obtaining an encapsulated data file storing a grid of input items (step 400), for example an ISOBMFF file storing a grid of input G-PCC items. In addition, an indication of the first item to decode and render (i.e. the grid item) may be obtained. If no indication of the first item to decode and render is obtained, the first item indicated in the encapsulated data file may be considered as being the first item to decode and render.

Next, the grid item to decode and render is obtained from the ISOBMFF file (step 405). This grid item may be encapsulated in the ISOBMFF file according to the GPCCGrid structure described above. It may be parsed to obtain, for example, the size of the grid, whether the input G-PCC items use the same_origin, whether these input G-PCC items are ordered using a line-scan order or a Morton order, and whether the size of a cell is included in the structure. If the size of the cells is included in the structure, it may be parsed from the ISOBMFF file to obtain this size.

In addition, a SingleItemTypeReferenceBox of type ‘dimg’ associated with the grid may be parsed to identify the input G-PCC items used by the grid. If the size of a cell is not included in the GPCCGrid structure, it may be obtained using the size of the input G-PCC items. For example, in a particular embodiment, the size of all the input G-PCC items is the same and the size of a cell is obtained using the size of any of the input G-PCC items. In a variant, the size of a cell along an axis may be computed as the maximum size of an input G-PCC item along this axis.

The subsets of encoded point cloud data of the input G-PCC items identified in the SingleItemTypeReferenceBox of type ‘dimg’ associated with the grid are then obtained from the ISOBMFF file.

Next, the subsets of encoded point cloud data are decoded and rendered (step 410). Decoding a subset of encoded point cloud data, i.e., decoding a point cloud, may be carried out, for example, according to MPEG-I Part-9 specification. The rendering may include generating structures in a memory unit (for example a random access memory) for representing the decoded point cloud, transmitting these structures to a graphic card, and generating a display of the point cloud.

If the same_origin field of the GPCCGrid structure used is set to the second value, i.e. 0 according to the example given above, the positions of the points of a decoded point cloud may be translated into a reference frame corresponding to the grid, for example using the translation described above. Possibly, a further translation may be applied to the decoded points for changing the origin of the reference frame used by the grid. This translation may be applied while decoding the point cloud, after decoding it and before rendering it, or as part of the rendering process.

If the points of the subsets of encoded point cloud data do not use the same origin, the points of the decoded point clouds may be translated before being rendered. Possibly, this translation may be carried out as part of the decoding or as part of the rendering.

Preferably, the decoding and rendering are carried out independently for each subset of encoded point cloud data, as much as possible. For instance, the decoding, the generation of structures in a memory unit for representing a decoded point cloud, and the transmission of these structures to a graphic card may be carried out in parallel for several subsets of encoded point cloud data, i.e. for several point clouds. Advantageously, the memory structures used to represent decoded point clouds may be organized in such a way that a memory structure among the most used memory structures is only used for the decoding and rendering of one decoded point cloud. For example, the representation of the 3D space may be divided into several sub-volumes, each sub-volume being represented using one or more memory structures. These sub-volumes may be built such that each sub-volume correspond to one cell of the grid. In this way, during the decoding of a subset of encoded point cloud data, only the memory structures representing the associated sub-volume are accessed and these memory structures are only accessed during the decoding of this subset of encoded point cloud data. In this example, some global memory structures may be used to organize the memory structures corresponding to each sub-volume. However, these global memory structures are mostly accessed at step 405 while parsing the grid and not while decoding the subsets of encoded point cloud data. Possibly, several sub-volumes may correspond to one cell of the grid, each sub-volume corresponding to only one cell of the grid.

Decoding a point cloud previously encoded as a grid of subsets of point could data may advantageously increase the decoding speed of the point cloud as several decoding operations may be carried out in parallel. In addition, part of the rendering process, may also be carried out in parallel.

In some embodiments, step 410 may further optimize the decoding and rendering of a point cloud encoded as a grid. In these embodiments, the description of the grid contained in the GPCCGrid structure may be used to compute the location of each cell of the grid. Accordingly, the cells of the grid may be filtered according to their location, selecting only the cells that are relevant for the rendering. For instance, only the cells corresponding to point cloud data visible inside a viewport used for the rendering may be selected. As another example, only the cells corresponding to point cloud data visible inside the viewport and close to the viewing point are selected. Memory structures for rendering the point cloud are created. These structures may be adapted to the selected cells. For example, the rendering space may be divided along limits corresponding to the limits between the grid's cells. Accordingly, only the subsets of encoded point cloud data corresponding to the selected cells are parsed from the ISOBMFF file. These subsets of encoded point cloud data are decoded and stored inside the memory structures in a parallel way, before being rendered, here again in a parallel way.

According to other embodiments, one or more input G-PCC items may extend outside the boundaries of their grid's cell. This may be useful, for instance, when storing the output of a rotating LiDAR as a grid. Indeed, a rotating LiDAR captures a point cloud by using an array of vertically aligned lasers. This array allows capturing points in a vertical plane. For capturing points in a volume, this array is rotated along a vertical axis. Hence, a full rotation of the LiDAR can be split into a grid of 4 cells, each cell corresponding to a quadrant of the volume scanned by the LiDAR. This allows encoding the points of each quadrant as soon as they have been captured, without waiting for a complete capture of the whole volume.

However, for some rotating LiDARs, the lasers are not perfectly aligned in the same vertical plane: it exists a slight offset between the lasers. This may result from improving the compactness of the laser array. This means that the points captured during a quarter of a rotation of the LiDAR may expand outside the corresponding quadrant. While it is possible to filter the captured points and to reassign them to the correct quadrant, this makes the encoding process more complex and introduces some latency in the encoding process. To cope with this problem, the grid as described above may be modified to allow points of input G-PCC items to extend outside the boundaries of their grid's cell. The structure describing a grid may be modified as follows to support this feature:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(1) same_origin; | |
| unsigned int(1) morton_order; | |
| unsigned int(1) has_cell_size; | |
| unsigned int(1) overlap; | |
| unsigned int(4) reserved; | |
| if (has_cell_size == 1) { | |
| unsigned int(8) | precision; |
| Vector3 | cell_size(precision); |

}
}

wherein the overlap field indicates whether the input G-PCC items fit into their grid's cell or may extend outside it. If the value of this field is set to a first value, for example 1, the points of the input G-PCC items may extend outside their grid's cell. Alternatively, if the value of this field is set to a second value, for example 0, the points of the input G-PCC items are fully contained inside their grid's cell.

According to these embodiments, the encoder determines whether the input G-PCC items extend outside their grid's cell or not. This determination may be carried out while obtaining the grid characteristics at step 305 in FIG. 3. When building a grid using already encoded point clouds, this determination may be carried out by checking the encoded point cloud characteristics. Accordingly, if it is determined that some input G-PCC items extend outside their grid's cell, the overlap field is set to the first value (i.e. 1 according to the example given above) when creating the GPCCGrid structure at step 320 in FIG. 3. Otherwise, this flag is set to the second value (i.e. 0 according to the example given above).

Still according to these embodiments, the decoder determines at step 405 in FIG. 4 whether the input G-PCC items extend outside the grid's cell or not by checking the value of the overlap field. If it is determined that the value of the overlap field is set to the first value (i.e. 1 according to the example given above), at step 410 in FIG. 4, the points of an input G-PCC item located outside the boundaries of its cell may be moved into a structure corresponding to the region where they are located. Possibly, the points of an input G-PCC item located outside the boundaries of its cell may be discarded, meaning that an input G-PCC item is cropped to fit into the boundaries of its grid's cell.

If it is determined that the value of the overlap field is set to the second value (i.e. 0 according to the example given above), the step 410 in FIG. 4 is realized as described previously, in particular by carrying out independently as much as possible the decoding and rendering for each subset of encoded point cloud data.

In a variant of these embodiments, the structure describing a grid may indicate whether an input G-PCC item extending outside the boundaries of its grid's cell is to be cropped or not.

In another variant, the extension of input G-PCC items outside the boundaries of their grid's cell may be specified with a finer granularity. For instance, an overlap field may be associated with each input G-PCC item, indicating whether this input G-PCC item extends outside the boundaries of its grid's cell. As another example, an overlap field may be associated with each input G-PCC item for each of its neighboring grid's cell to indicate whether this input G-PCC item extends into this neighboring grid's cell.

In some embodiments, the limits of the cell may be defined more strictly, a face shared between two cells belonging to only one of these cells, for example the cell with the largest coordinates. Similarly, an edge or a vertex shared between two or more cells may belong to only one of these cells, for example the cell with the largest coordinates. In these embodiments, an input G-PCC item may extend outside its grid's cell if it contain a point located on a face of its cell that doesn't belong to its cell.

Still in some embodiments, the grid may be sparse, one or more of the cells not containing any point. An empty cell may be represented using a G-PCC item not containing any point. As an optimization, the GPCCGrid structure may indicate which cells contain points and which cells are empty, for example as follows:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(1) same_origin; | |
| unsigned int(1) morton_order; | |
| unsigned int(1) has_cell_size; | |
| unsigned int(1) sparse; | |
| unsigned int(4) reserved; | |
| if (has_cell_size == 1) { | |
| unsigned int(8) | precision; |
| Vector3 | cell_size(precision); |

```
  }
  if (sparse == 1) {
    for (int i=0; i < width * depth * height; i++) {
      unsigned int(1) occupied;
    }
  }
}
```

where the sparse field indicates whether the grid is sparse or not. If the value of this field is set to a first value, for example 1, the grid is sparse and for each cell, an occupied field indicates whether the cell contains one or more points. If the value of the occupied field corresponding to a given cell is set to a first value, for example 1, this cell is associated with a G-PCC item in the list of input G-PCC items signaled in the SingleItemTypeReferenceBox of type ‘dimg’. Otherwise, if the value of the occupied field corresponding to a given cell is set to a second value, for example 0, this cell is not associated with any G-PCC item in the list of input G-PCC items signaled in the SingleItemTypeReferenceBox of type ‘dimg’ (i.e. the cell is empty).

The occupied values for the different input G-PCC items may be listed according to their ordering.

Still according to some embodiments, the reference frame used for the input G-PCC items may differ from one item to another: some input G-PCC items may use the same reference frame as the grid while other input G-PCC items may use a reference frame that is local to their cell. These different reference frames may be indicated thanks to the following structure:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(2) same_origin; | |
| unsigned int(1) morton_order; | |
| unsigned int(1) has_cell_size; | |
| unsigned int(4) reserved; | |
| if (has_cell_size == 1) { | |
| unsigned int(8) | precision; |
| Vector3 | cell_size(precision); |
| } | |
| if (same_origin == 2) { | |
| unsigned int(8) | origin_precision; |
| Vector3 | global_origin(origin_precision); |

```
    for (int i=0; i < width * depth * height; i++) {
      unsigned int(1) global_cell_origin;
    }
  }
}
```

with width equals width_minus_one plus one; With height equals height_minus_one plus one; With depth equals depth_minus_one plus one; wherein the same_origin field may have three different values. If the value of this field is set to a first value, for example 0, each input G-PCC item is defined using its own reference frame. If the value of this field is set to a second value, for example 1, all the input G-PCC items are defined using the same reference frame. If the value of this field is set to a third value, for example 2, different reference frames may be used for the different input G-PCC items. For each cell, a global_cell_origin field indicates whether the corresponding input G-PCC item uses its own reference frame or a common reference frame. If the value of the global_cell_origin field associated with a cell is set to a first value, for example 0, the corresponding input G-PCC item uses its own reference frame and if the value of the global_cell_origin field associated with a cell is set to a second value, for example 1, the corresponding input G-PCC item uses a common reference frame.

For an input G-PCC item using its own reference frame, a translation may be applied to its points to transform them into the global reference frame using the following relations:

$${x}_{g} = {x}_{l} + {c}_{x} * {i}_{x}$$

$${y}_{g} = {y}_{l} + {c}_{y} * {i}_{y}$$

$${z}_{g} = {z}_{l} + {c}_{z} * {i}_{z}$$

In addition, a second translation may be applied to use a reference frame different from the one of the cell located at position (0, 0, 0). This translation may be defined in the structure by the global_origin field.

The global_cell_origin fields may be ordered according to the input G-PCC items order.

Still in some embodiments, when one or more input G-PCC items are defined using their own reference frame, for instance when the value of the same_origin flag is set to a second value, for example 0, one of the input G-PCC item, the reference input G-PCC item, may be used to define the reference frame of the grid. This reference input G-PCC item may be the input G-PCC item located at the position (0, 0, 0). It may be another input G-PCC item signaled in the grid structure.

The translation between the reference frame of the grid and the reference frame of the cell containing the reference input G-PCC item may be computed by aligning the reference input G-PCC item with its grid's cell and computing the translation between them. If the size of the reference input G-PCC item is the size of the grid's cell, this alignment may be realized directly. If the size of the reference input G-PCC item is smaller than the size of the grid's cell, the reference input G-PCC item may be aligned with the grid's cell by centering it inside the grid's cell, or by aligning it with one or more of the faces of the grid's cell, or by a combination of the two.

Still in some embodiments, the input G-PCC items of the grid may have different sizes, an input G-PCC item may correspond to several cells of the grid. In these embodiments, a grid may be described with the following structure:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(1) same_origin; | |
| unsigned int(1) morton_order; | |
| unsigned int(1) has_cell_size; | |
| unsigned int(5) reserved; | |
| if (has_cell_size == 1) { | |
| unsigned int(8) | precision; |
| Vector3(precision) | cell_size; |

```
  }
  for (int i=0; i < reference_count; i++) {
    unsigned int(8) item_width_minus_one;
    unsigned int(8) item_depth_minus_one;
    unsigned int(8) item_height_minus_one;
  }
}
```

wherein the location and size of the different input G-PCC items may be signaled by the item_width_minus_one, item_depth_minus_one, and item_height_minus_one fields. For this signaling, the cells of the grid are scanned according to the ordering specified by the morton_order field. For each cell, if it corresponds to an input G-PCC item previously described, it is skipped. Otherwise, the cell is the current cell, located at position (iₓ, i_{y}, i_{z}). The next entry in the SingleItemTypeReferenceBox of type ‘dimg’ associated with the grid corresponds to the current input G-PCC item. The number of cells spanned by this current input G-PCC item is specified by the sₓ, s_{y}, and s_{z} values, as specified by the current item_width_minus_one, item_height_minus_one and item_depth_minus_one fields. The current input G-PCC item spans the cells from iₓ to iₓ+sₓ−1 along the X axis, from i_{y} to i_{y}+s_{y}−1 along the Y axis, and from i_{z} to i_{z}+s_{z}−1 along the Z axis.

Still according to some embodiments, the bounding box of the grid derived item may be specified and may be different from the bounding box of the grid. For example, the bounding box of the grid may be smaller than the grid, meaning that the point cloud obtained by combining the input G-PCC items in a grid is cropped for obtaining the point cloud corresponding to the grid derived item. As another example, the bounding box of the grid may have a larger extent than the grid itself. In this variant, the grid may be described with the following structure:

| aligned(8) class GPCCGrid { | |
|---|---|
| unsigned int(8) version = 0; | |
| unsigned int(8) flags; | |
| unsigned int(8) width_minus_one; | |
| unsigned int(8) depth_minus_one; | |
| unsigned int(8) height_minus_one; | |
| unsigned int(1) same_origin; | |
| unsigned int(1) morton_order; | |
| unsigned int(1) has_cell_size; | |
| unsigned int(5) reserved; | |
| if (has_cell_size == 1) { | |
| unsigned int(8) | precision; |
| Vector3(precision) | cell_size; |
| } | |
| unsigned int(8) | output_precision; |
| Vector3(output_precision) | output_position; |
| Vector3(output_precision) | output_size; |

}

wherein the bounding box of the grid is specified by the output_position and output_size fields. The output_precision field specifies the precision used for the output_position and output_size fields.

Possibly, the bounding box of the grid may be specified using an item property associated with the grid derived item, for example a bounding box item property or a size item property. Possibly, the bounding box of the grid may be specified using a crop transformative item property associated with the grid derived item.

### 3D Fusion

It has been observed that there exist cases according to which a 3D volume may be split according to an irregular way, not corresponding to a grid. For instance, a scene may be captured by a LIDAR successively located at different positions and the resulting point cloud data may be split into several subsets of point cloud data centered on the different capture positions. This resulting point cloud may be represented as the fusion of several subsets of point cloud data.

A 3D fusion G-PCC item may be represented as an item with an item_type having a specific value, for example the value ‘fus3’. This 3D fusion item aims at combining one or more input G-PCC items arranged in an irregular way. Thus, an item with item_type value of ‘fus3’ defines a derived point cloud item whose reconstructed point cloud is formed by combining one or more input point clouds.

The input point clouds are inserted in the order of SingleItemTypeReferenceBox of type ‘dimg’ for this derived point cloud item within the ItemReferenceBox. In the SingleItemTypeReferenceBox of type ‘dimg’, the value of from_item_ID identifies the derived point cloud item of type ‘fus3’ and the values of to_item_ID identify the input point clouds.

When removing an item that is marked as an input point cloud of a point cloud fusion item, the content of the point cloud fusion item might need to be rewritten.

The parameters associated with the derived point cloud item specify some characteristics of the 3D fusion item and may have the following structure:

```
aligned(8) class GPCCFusion {
  unsigned int(8) version = 0;
  unsigned int(8) flags;
  unsigned int(1) overlap;
  unsigned int(1) same_origin;
  unsigned int(6) reserved;
  if (same_origin == 0) {
    unsigned int(8) precision;
    for (int i=0; i < reference_count; i++) {
      Vector3 anchor(precision) ;
  }
}
```

wherein the version field signals the version of the structure and the flags field may signal some options for the structure. version or flags should be equal to 0 if there is no version defined or flags defined respectively.

The overlap field indicates whether some input G-PCC items of the 3D fusion item may overlap or not. If the value of the overlap field is set to a first value, for example 1, some input G-PCC items of the 3D fusion item may or may not overlap, i.e. the intersection of the bounding boxes of any pair of input point cloud may or may not have an empty volume. If the value of the overlap field is set to a second value, for example 0, none of the input G-PCC items of the 3D fusion item overlaps, i.e. the intersection of the bounding boxes of any pair of input point cloud has an empty volume. Two input G-PCC items may be considered as not overlapping if the intersection of their bounding boxes is an empty volume. In a variant, two input G-PCC items may be considered as not overlapping if the intersection of their bounding boxes is an empty volume and their bounding boxes share a face, an edge, or a vertex.

The same_origin flag indicates whether the input G-PCC items combined by the 3D fusion item use the same reference frame or not. If the value of the same_origin flag is set to a first value, for example 1, all input G-PCC items are defined using the same reference frame or coordinate system. In this case, the input G-PCC items may be combined without applying a translation to them. Otherwise, if the value of the same_origin flag is set to a second value, for example 0, each input G-PCC item is defined using its own reference frame. In this latter case, a translation may be applied to the coordinates of a point of an input G-PCC item to compute its coordinates in a global reference frame for the 3D fusion item. For each input G-PCC item, the translation from its local reference frame to a common reference frame may be signaled by the anchor field corresponding to this input G-PCC item, i.e. the i^{th} anchor applies to the i^{th} occurrence in the order of SingleItemTypeReferenceBox of type ‘dimg’ for this derived point cloud item within the ItemReferenceBox. The global coordinates for a point of an input G-PCC item may be computed from its decoded coordinates as follows:

$${x}_{g} = {x}_{l} + {a}_{x}$$

$${y}_{g} = {y}_{l} + {a}_{y}$$

$${z}_{g} = {z}_{l} + {a}_{z}$$

wherein x_{g}, y_{g}, and z_{g} are the coordinate of the point in the global reference frame, xₗ, yₗ, and zₗ are the coordinate of the point in the local reference frame of the input G-PCC item, and aₓ, a_{y}, and a_{z} are the coordinates of the anchor for the input G-PCC item along the X, Y, and Z axes as signaled by the anchor field corresponding to this input G-PCC item.

The precision field indicates the precision used for encoding the anchors of the input G-PCC item. For each input G-PCC item, the anchor field signals the coordinates of its anchor, used for converting the coordinates of the points of the input G-PCC item from the local reference frame used by the input G-PCC item to the common reference frame used by the 3D fusion item. The anchor fields may be ordered in the order of the input G-PCC items.

The input G-PCC items may be signaled in a of type SingleItemTypeReferenceBox ‘dimg’. In this SingleItemTypeReferenceBox, the value of the from_item_Id field identifies the derived point cloud item. The value of the reference_count field indicates the number of input G-PCC items. reference_count is obtained from the SingleItemTypeReferenceBox of type ‘dimg’ where this item is identified by the from_item_ID field. The value of the to_item_ID fields identify the input G-PCC items. Again, the SingleItemTypeReferenceBox may be referred to as the item reference.

According to some embodiments, each input G-PCC item may have an associated same_origin flag. In such embodiments, the 3D fusion item may have the following structure:

```
aligned(8) class GPCCFusion {
  unsigned int(8) version = 0;
  unsigned int(8) flags;
  unsigned int(1) overlap;
  unsigned int(7) reserved;
  unsigned int(8) precision;
  for (int i=0; i < reference_count; i++) {
    unsigned int(1) same_origin;
    unsigned int(7) reserved;
    if (same_origin == 0) {
      Vector3 anchor(precision) ;
    }
  }
}
```

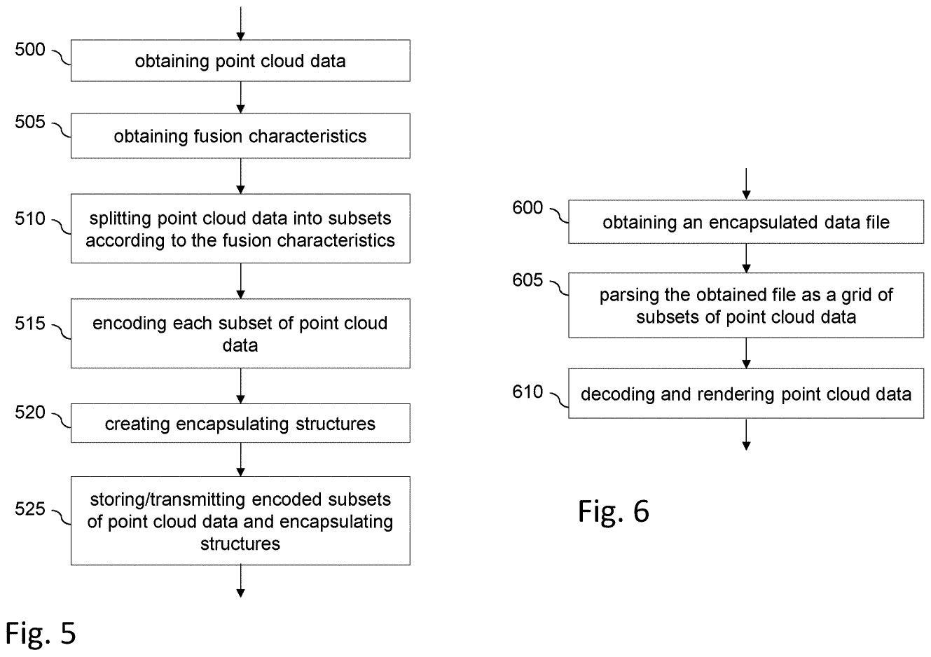

FIG. 5 illustrates an example of steps for storing and/or transmitting point cloud data as a 3D fusion item of input G-PCC items, according to some embodiments of the invention.

As illustrated, a first step is directed to obtaining the point cloud data to store and/or to transmit (step 500). These point cloud data may be obtained directly from a sensor such as a LiDAR. It may also be the result of processing one or more point clouds captured by a sensor. For example, several point clouds may be captured by a LiDAR, registered to transform them so that they use the same reference frame and then, may be combined into a single point cloud. The point cloud may also be obtained as a set of several point clouds to be combined together. For example, it may be a set of point clouds captured by a LiDAR at different positions in a scene or by different LiDARs at different positions in a scene.

Next, the target characteristics of the 3D fusion item are obtained (step 505).

In this step, an indication on how to split the point cloud data obtained at step 500 into subsets of point cloud data may be obtained. This indication may be based on 3D regions for splitting the point cloud data. It may be based on a list of points corresponding to each subset of point cloud data. It may also be based on characteristics of the points of the point cloud data. For example, the point cloud data may be split based on the capture time of the points so that each subset of point cloud data corresponds to different periods of time. As another example, the point cloud data may be split by grouping the points around a set of center points, each point being grouped with the closest center point, so that each subset of point cloud data comprises points close to each other.

In addition, an indication on whether to use the same origin for all the input G-PCC items or not may be obtained. Possibly, when the same origin is used for all the input G-PCC items, a translation to be applied to all the input G-PCC items before encoding them may be obtained. Likewise, when a same origin is not used for the input G-PCC items, a translation to be applied to the 3D fusion item may be obtained.

According to some embodiments, it is determined whether the point clouds corresponding to the subsets of point cloud data may overlap or not. This may comprise obtaining an indication of whether or not these point clouds may overlap. It may also comprise analyzing the indication on how the point cloud data are split. For example, if this indication is based on 3D regions, it may be determined from these 3D regions whether the point clouds corresponding to the subsets of point cloud data overlap or not. For instance, if the 3D regions are cuboids aligned with the axes of the reference frame, the point clouds corresponding to the subsets of point cloud data do not overlap. On the contrary, if the 3D regions are not aligned with the axes of the reference frame, the point clouds may overlap. As another example, if this indication is based on characteristics of the points, it may be determined that the point clouds may overlap. This determination may be carried out by checking directly whether the point clouds overlap. For instance, this determination may be carried out by computing the bounding boxes of the point clouds corresponding to the subsets of point cloud data and by checking whether these bounding boxes overlap. In this latter case, the determination may be carried out at the end of step 510 once the point cloud data has been split into subsets of point cloud data.

In addition, the ordering of the input G-PCC items in the 3D fusion item may be obtained. This ordering may be obtained in link with the indication on how to split the point cloud data. For example, if the indication is based on 3D regions for splitting the point cloud data, an ordering may be associated with these 3D regions for indicating the ordering of the input items. As another example, if the splitting is based on characteristics of the points of the point cloud data, the ordering of the input items may be based on these characteristics or on an indication links with these characteristics. For instance, if the point cloud data is split based on the capture time of the points, the input items may be ordered according to this capture time.

It is to be noted that step 505 may be carried out before step 500 or simultaneously with step 500.

Next, the point cloud data obtained in step 500 are split into subsets of point cloud data according to the indication obtained in step 505 (step 510). It is observed that if the point cloud data are obtained as a plurality of subsets of point cloud data in step 500, step 510 is skipped.

Next, the point cloud data of each subset of point cloud data are processed (step 515), for example encoded. Preferably, processing the point cloud data of each subset of point cloud data is carried out independently for each subset. For instance, the point cloud data of each subset of point cloud data may be encoded in parallel. Still for the sake of illustration, the encoding may be carried out using the MPEG-I Part-9 specification.

During this step, if the same origin is used for all the input G-PCC items, the translation possibly obtained at step 505 may be applied to the points of each subset of point cloud data before encoding them or as part of the encoding. If a same origin is not used for all the input G-PCC items, the points of each subset of point cloud data may be translated as a function of its own reference frame determined by its anchor before encoding it or while encoding it.

Next, the structures for encapsulating the 3D fusion item and the subsets of encoded point clouds are created (step 520). For instance, a GPCCFusion structure as described above may be created for describing the 3D fusion item and storing its characteristics. In addition, G-PCC items may be created for describing each subset of encoded point cloud data. Possibly, each subset of encoded point cloud data may be described either by using a single G-PCC item or by using several G-PCC items. A SingleItemTypeReferenceBox of type ‘dimg’ may be created for linking the input G-PCC items describing the subsets of encoded point cloud data with the 3D fusion item. The ordering of the input G-PCC items inside the SingleItemTypeReferenceBox may depend on the ordering obtained at step 505.

It is to be noted that step 520 or some sub-steps of step 520 may be carried out simultaneously to step 515 or to some sub-steps of step 515.

Next, the subsets of encoded point cloud data and the encapsulating structures created in step 520, comprising the item reference establishing a link between the derived item and the input items (e.g. SingleItemTypeReferenceBox of type ‘dimg’), are stored in an encapsulated data file (step 535), for example an encapsulated data file complying with the ISOBMF format. Possibly, the encapsulated data file is stored in a memory unit or in a hard drive. Possibly, the encapsulated data file is sent over a communication network.

Encoding point cloud data as a 3D fusion item may advantageously increase the encoding speed of the point cloud as several encoding operations may be carried out in parallel.

According to some embodiments, the point cloud data are obtained as a plurality of subsets of point cloud data (step 500) and the different subsets of point cloud data are not obtained simultaneously. In such embodiments, one or more subsets of point cloud data may be processed independently of the others. The one or more subsets of point cloud data are encoded as described in relation to step 515, encapsulating structures are created to represent them as described in relation to step 520, and the subsets of encoded point cloud data and their encapsulating structures are stored and/or transmitted as described in relation to step 525.

FIG. 6 illustrates an example of steps for decoding and rendering point cloud data stored as a 3D fusion of input G-PCC items according to some embodiments of the invention.

In a first step, an encapsulated data file storing a 3D fusion of G-PCC items, for example an encapsulated data file complying with the ISOBMF format, is obtained (step 600). In addition, an indication of the first item to decode and render (i.e. the fusion item) may be obtained. If no indication of the first item to decode and render is obtained, the first item signaled in the ISOBMFF file may be considered as the item to decode and render.

Next, the 3D fusion item to decode and render is obtained from the encapsulated data file (step 605). This 3D fusion item may be encoded according to the GPCCFusion structure described above. It may be parsed to obtain, for example, an indication as to whether the input G-PCC items use the same origin and/or whether these input G-PCC items may overlap.

Furthermore, the SingleItemTypeReferenceBox of type ‘dimg’ associated with the 3D fusion item may be parsed to identify the input G-PCC items used by the 3D fusion item.

In addition, the encoded point cloud data of each input G-PCC item may be obtained from the encapsulated data file (e.g. ISOBMFF file). Each input G-PCC item may contain a subset of the encoded point cloud data.

Next, the encoded point cloud data of the input G-PCC items (or of some of the input G-PCC items) are decoded and rendered. For the sake of illustration, decoding encoded point cloud data may be carried out according to the MPEG-I Part-9 specification. The rendering step may include generating structures in a memory unit for representing the decoded point cloud data, transmitting these structures to a graphic card, and generating a display of the point cloud data.

If the same_origin field of the GPCCFusion structure is set to the second value (i.e. 0 according to the previous example), meaning that each subset of point cloud data uses its own reference frame, the position of the points of a subset of decoded point cloud data may be translated into a reference frame corresponding to the 3D fusion item, for example using the translation described above. Possibly, a further translation may be applied to the decoded points for changing the origin of the reference frame used by the 3D fusion item. This translation may be applied while decoding the point cloud data of a subset, after decoding them and before rendering them, or as part of the rendering process.

If the same_origin field of the GPCCFusion structure is set to the first value (i.e. 1 according to the previous example), meaning that the subsets of encoded point cloud data of the subsets use the same origin, the points of the subsets of decoded point cloud data may be translated before being rendered. Possibly, this translation may be carried out as part of the decoding or as part of the rendering.

Preferably, the decoding and rendering are carried out independently for each subset of encoded point cloud data, as much as possible. For instance, the decoding, the generation of structures in a memory unit for representing a decoded point cloud, and the transmission of these structures to a graphic card may be carried out in parallel for several subsets of encoded point cloud data.

During the decoding and rendering of the encoded point cloud data of the subsets, the information of whether the corresponding point clouds may overlap may be used to identify the steps of this process that may be carried out independently on the encoded point cloud data.

Indeed, if the point clouds corresponding to the decoded point cloud data subsets are signaled as not overlapping, the memory structures used to represent these point clouds may be organized in such a way that a memory structure among the most used memory structures is only used for the decoding and rendering of one of these point clouds. For example, the representation of the 3D space may be divided into several sub-volumes, each sub-volume being represented using one or more memory structures. These sub-volumes may be built such that each sub-volume corresponds to the bounding box of the points of one subset of point cloud data. In this way, during the decoding of a subset of encoded point cloud data, only the memory structures representing the associated sub-volume are accessed and these memory structures are only accessed during the decoding of this subset. In this example, some global memory structures may be used to organize the memory structures corresponding to each sub-volume. However, these global memory structures are mostly accessed at step 605 while parsing the 3D fusion item and not during the decoding of the encoded point cloud data. Possibly, several sub-volumes may correspond to one subset of encoded point cloud data, each sub-volume corresponding to only one subset of encoded point cloud data.

On the contrary, if the point clouds corresponding to the subsets of point cloud data are signaled as overlapping, the decoded point cloud data subsets may be reorganized before being rendered. For example, the subsets of encoded point cloud data may be decoded independently and then, the resulting data may be merged into memory structures representing different point clouds. As another example, the subsets of encoded point cloud data may be decoded simultaneously and the resulting data may be stored directly into the memory structures representing all the decoded point cloud data subsets, while taking care of keeping the content of the memory structures coherent in the case of simultaneous accesses. The organization of the memory structures may be arranged in such a way that some memory structures contain only data from a single subset of point cloud data, while some other memory structures contain data from several subsets of point cloud data. In this way, there is no need for merging data or taking care of simultaneous access to memory structures containing only data from a single subset of point cloud data.

Decoding a point cloud previously encoded as a 3D fusion item may advantageously increase the decoding speed of the point cloud as several decoding operations may be carried out in parallel. In addition, part of the rendering process, may also be carried out in parallel.

According to some embodiments, two input G-PCC items may be considered as not overlapping if no point of one of these input G-PCC items is contained inside the bounding box of the other input G-PCC item. During step 610, the 3D space may be divided into sub-volumes such that each sub-volume containing one or more points from the point cloud represented by the 3D fusion item corresponds to only one subset of encoded point cloud data. In these embodiments, a sub-volume corresponding to the intersection of the bounding boxes of two or more input G-PCC items is empty and does not contain any point from the point cloud represented by the 3D fusion item.

Still according to some embodiments, the overlapping of input G-PCC items may be specified with a finer granularity. For instance, an overlap field may be associated with each input G-PCC item indicating whether this input G-PCC item overlaps another input G-PCC item. In combination with the previous embodiments, this overlap field may indicate whether the bounding box of the input G-PCC item contains points from other input G-PCC items or not.

As another example, an overlap field may be associated with each pair of input G-PCC items indicating whether these two input G-PCC items overlap or not. In combination with the previous embodiments, this overlap field may indicate whether the bounding box of one of these input G-PCC item contains points from the other input G-PCC item or not.

Possibly, the bounding box of the 3D fusion derived item may be computed as a combination of the bounding boxes of the input G-PCC items. If the value of the same_origin field of the GPCCFusion structure is set to the second value (i.e. 0 according to the previous example), meaning that each subset of point cloud data uses its own reference frame, this computation may be carried out by translating the bounding boxes of the input G-PCC items. Then, the bounding box of the 3D fusion derived item may be computed as spanning from the smallest coordinate value of the input items' bounding boxes to the largest coordinate value of these bounding boxes along each coordinate axis.

In a variant, the bounding box of the 3D fusion derived item may be specified and may be different from the combination of the bounding boxes of the input G-PCC items of the 3D fusion item. For example, the bounding box of the 3D fusion derived item may be smaller than the combination of the bounding boxes of the input G-PCC items, meaning that the point cloud obtained by combining the input G-PCC items as a 3D fusion item is cropped for obtaining the point cloud corresponding to the 3D fusion derived item. As another example, the bounding box of the 3D fusion derived item may have a larger extent than the combination of the bounding boxes of the input G-PCC items. In this variant, the 3D fusion derived item may be described with the following structure:

| aligned(8) class GPCCFusion { | |
|---|---|
| unsigned int(8) version = 0; | |
| unsigned int(8) flags; | |
| unsigned int(1) overlap; | |
| unsigned int(1) same_origin; | |
| unsigned int(6) reserved; | |
| if (same_origin == 1) { | |
| unsigned int(8) precision; | |
| for (int i=0; i < reference_count; i++) { | |
| Vector3 anchor(precision) ; | |
| } | |
| unsigned int(8) | output_precision; |
| Vector3(output_precision) | output_position; |
| Vector3(output_precision) | output_size; |

}

The bounding box of the 3D fusion derived item may be specified by the output_position and output_size fields. The output_precision field specifies the precision used for the output_position and output_size fields.

Still as a variant, the 3D fusion item may be referred to as a 3D merge and be represented as a derived item with an item_type value of ‘mrg3’. The GPCCFusion structure may be called GPCCMerge.

In some embodiments, one or more input items for a 3D grid item or for a 3D fusion item may be 3D grid items and/or 3D fusion items.

In some embodiments, several embodiments of the 3D grid item may be used simultaneously. The different embodiments may be signaled using different values for the version field or different values for the item_type.

In some embodiments, several embodiments of the 3D fusion item may be used simultaneously. The different embodiments may be signaled using different values for the version field or different values for the item_type.

### Structures

The Vector3 structure used in different structures described above may be the Vector3 structure defined by MPEG-I Part-7 as follows:

```
aligned(8) class Vector3(unsigned int precision_bytes_minus1) {
  signed int ( (precision_bytes_minus1+1) * 8) x;
  signed int ( (precision_bytes_minus1+1) * 8) y;
  signed int ( (precision_bytes_minus1+1) * 8) z;
}
```

The Vector3 structure may also represent the x, y, and z coordinates using floating point numbers of fixed point numbers like in the following structure:

```
aligned(8) class Vector3(unsigned int precision_bytes_minus1) {
  signed int( (precision_bytes_minus1+1) * 16) x;
  signed int( (precision_bytes_minus1+1) * 16) y;
  signed int( (precision_bytes_minus1+1) * 16) z;
}
```

where the x, y, and z coordinates are represented using fixed point numbers, with precision_bytes_minus1+1 bytes for the integer part and precision_bytes_minus1+1 bytes for the decimal part.

### Item Properties

Several item properties may be associated with G-PCC items, an identity point cloud item, 3D grid derived point cloud items, and/or 3D fusion derived point cloud items.

The BoundingBox item property specifies the bounding box of a G-PCC item, an identity point cloud item, a 3D grid derived point cloud item, and/or a 3D fusion derived point cloud item. This item property may have the following structure:

| aligned(8) class BoundingBox | |
|---|---|
| extends ItemFullProperty(‘box3’ , version = 0, flags = 0) { | |
| unsigned int(8) precision; | |
| Vector3 | position(precision) ; |
| Vector3 | size(precision) ; |

}

In this structure, the position field is the reference point for the bounding box and specifies the minimum values for the x, y, and z coordinates of the points contained in the associated item or derived item. The size field specifies the extent of the bounding box along the x, y, and z coordinates.

The bounding box may also be specified using two points, for example two points corresponding to two opposite corners of the bounding box.

The bounding box may also be specified using the center of the bounding box and its size.

The Size item property specifies the size of a G-PCC item, an identity point cloud item, a 3D grid derived point cloud item, and/or a 3D fusion derived point cloud item. This item property may have the following structure:

```
aligned(8) class Size
extends ItemFullProperty(‘siz3’, version = 0, flags = 0) {
  unsigned int(8) precision;
  Vector3 size(precision) ;
}
```

In this structure, the size field specifies the size of the item along the x, y, and z coordinates.

The Translation transformative item property specifies a translation to apply to a G-PCC item, an identity point cloud item, a 3D grid derived point cloud item, and/or a 3D fusion derived point cloud item. This transformative item property may have the following structure:

```
aligned(8) class Translation
extends ItemFullProperty(‘tra3’, version = 0, flags = 0) {
  unsigned int(8) precision;
  Vector3 translation(precision) ;
}
```

In this structure, the translation field specifies the translation vector.

The Scaling transformative item property specifies a scaling to apply to a G-PCC item, to an identity point cloud item, to a 3D grid derived point cloud item or to a 3D fusion derived point cloud item. This transformative item property may have the following structure:

```
aligned(8) class Scaling
extends ItemFullProperty(‘sca3’, version = 0, flags = 0) {
  unsigned int(8) precision;
  Vector3 scaling(precision) ;
}
```

In this structure, the scaling field specifies the scaling to apply on the x, y, and z coordinates. Possibly a simpler scaling transformative item property may be defined, where the same scaling is applied on all the coordinates.

The Rotation transformative item property specifies a rotation to apply to a G-PCC item, an identity point cloud item, a 3D grid derived point cloud item, and/or a 3D fusion derived point cloud item. This transformative item property may have the following structure:

```
aligned(8) class Rotation
extends ItemFullProperty(‘rot3’, version = 0, flags = 0) {
  unsigned int(8) precision;
  Vector3 rotation(precision) ;
}
```

In this structure, the rotation field specifies the rotation as a quaternion. This quaternion being a unit quaternion, its three imaginary components may be specified, and its real component may be computed from these three imaginary components.

An extended Rotation transformative item property may be defined as follows:

| aligned(8) class Rotation | |
|---|---|
| extends ItemFullProperty(‘rot3’, version = 0, flags = 0) { | |
| unsigned int(8) precision; | |
| Vector3 | center(precision) ; |
| Vector3 | rotation(precision) ; |

}

In this structure, the center field specifies the center of the rotation.

The Transformation transformative item property specifies a generic 3D transformation that can combine a translation, a scaling and/or a rotation to apply to a G-PCC item, to an identity point cloud item, to a 3D grid derived point cloud item or to a 3D fusion derived point cloud item. This transformative item property may have the following structure:

```
aligned(8) class Transformation
extends ItemFullProperty(‘trf3’, version = 0, flags = 0) {
  unsigned int(8) precision;
      for (int i=0; i < 12; i++) {
    signed int((precision+1) * 16) coeff;
  }
}
```

In this structure, the coeff fields specify the coefficient of the transformation matrix. The transformation matrix may be a 4×4 homogeneous matrix, where the last row of coefficient is (0, 0, 0, 1). In this case, the Transformation structure may specify only 12 coefficients.

The Crop transformative item property specifies a crop to apply to a G-PCC item, an identity point cloud item, a 3D grid derived point cloud item, and/or a 3D fusion derived point cloud item. This transformative item property may have the following structure:

| aligned(8) class Crop | |
|---|---|
| extends ItemFullProperty(‘crp3’, version = 0, flags = 0) { | |
| unsigned int(8) precision; | |
| Vector3 | position(precision) ; |
| Vector3 | size(precision) ; |

}

The position and size fields specify the boundaries of the crop. Any point from the item located outside the boundaries of the crop is not part of the transformed point cloud.

The crop may also be specified using two points, for example two points corresponding to two opposite corners of the crop area.

The TransformedBoundingBox item property specifies the bounding box of a G-PCC item, an identity point cloud item, a 3D grid derived point cloud item, and/or a 3D fusion derived point cloud item after transformative item properties have been applied to it.

The TransformedBoundingBox item property may specify the bounding box of the item it is associated with after the application of all the transformative item properties listed before this TransformedBoundingBox item property and before the application of any transformative item property listed after it.

Indeed, computing the bounding box of a G-PCC item, an identity point cloud item, a 3D grid derived point cloud item, and/or a 3D fusion derived point cloud item after transformative item properties have been applied to it may require computing the bounding box from all the transformed points. For instance, after applying a translation, the bounding box of the transformed point cloud is the translation of the bounding box of the original point cloud. However, after applying a rotation, the rotated bounding box of the original point cloud is not aligned with the axes of the reference frame. A bounding box built from the rotated bounding box contains all the points of the rotated point cloud but may not fit tightly the rotated point cloud. Therefore, indicating the bounding box of the rotated point cloud may help decoding it and rendering it by indicating precisely the extent of the point cloud after transformation.

This item property may have the following structure:

| aligned(8) class TransformedBoundingBox | |
|---|---|
| extends ItemFullProperty(‘bot3’, version = 0, flags = 0) { | |
| unsigned int(8) precision; | |
| Vector3 | position(precision) ; |
| Vector3 | size(precision) ; |

}

In this structure, the position field is the reference point for the transformed bounding box and specifies the minimum values for the x, y, and z coordinates of the points contained in the associated item or derived item after transformative item properties have been applied to this associated item or derived item. The size field specifies the extent of the transformed bounding box along the x, y, and z coordinates.

The transformed bounding box may also be specified using two points, for example two points corresponding to two opposite corners of the bounding box.

The transformed bounding box may also be specified using the center of the bounding box and its size.

Possibly several transformed bounding box may be associated with an item or with a derived item corresponding to the application of different sets of transformative item properties.

The TransformedSize item property specifies the size of a G-PCC item, an identity point cloud item, a 3D grid derived point cloud item, and/or a 3D fusion derived point cloud item after transformative item properties have been applied to it.

The TransformedSize item property may specify the size of the item it is associated with after the application of all the transformative item properties listed before this TransformedSize item property and before the application of any transformative item property listed after it. This item property may have the following structure:

```
aligned(8) class TransformedSize
extends ItemFullProperty (‘szt3’, version = 0, flags = 0) {
  unsigned int(8) precision;
  Vector3 size(precision) ;
}
```

In this structure, the size field specifies the extent of the transformed bounding box along the x, y, and z coordinates.

### Variants

For the sake of illustration, the description of the different embodiments and variants above focused on using G-PCC items. In other embodiments, V3C items, as defined by MPEG-I Part-10, may be used. In yet other embodiments, other items describing encoded 3D data may be used. In yet other embodiments, derived items may combine different types of input items. For example, a grid derived item may combine G-PCC items and V3C items.

In the various embodiments, the ordering of the input items in the SingleItemTypeReferenceBox of type ‘dimg’ may be used for selecting which one prevails when several input items define 3D content at the same location. For instance, the latest input item in the ordering inside the SingleItemTypeReferenceBox may prevail. For example, if two input G-PCC items define a point at the same location, the point corresponding to the latest of the two input G-PCC items inside the SingleItemTypeReferenceBox order is kept, while the other point is discarded. As another example; when several input items define 3D content at the same location, these contents may be merged. For example, if two input G-PCC items define a point at the same location, then these points may be merged by combining their colors by computing an average color, and by taking the latest timestamp associated with these points. As yet another example, when several input items define 3D content at the same location, all these contents may be kept. For example, if two input G-PCC items define a point at the same location, then all these points or several of these points may be kept.

It is to be noted that the different 4 cc values used for indicating item types, item property types, or other information are given as examples only. Other values may be used for indicating these types.

In the different item structure described above, some fields are used for signaling values encoded on 1, 2 or a few bits. Some or all of these values may also be signaled using the flags field. Some or all of the options signaled using these fields may also be signaled using the version field.

### Example of Hardware to Carry Out Steps of the Method of Embodiments of the Present Disclosure

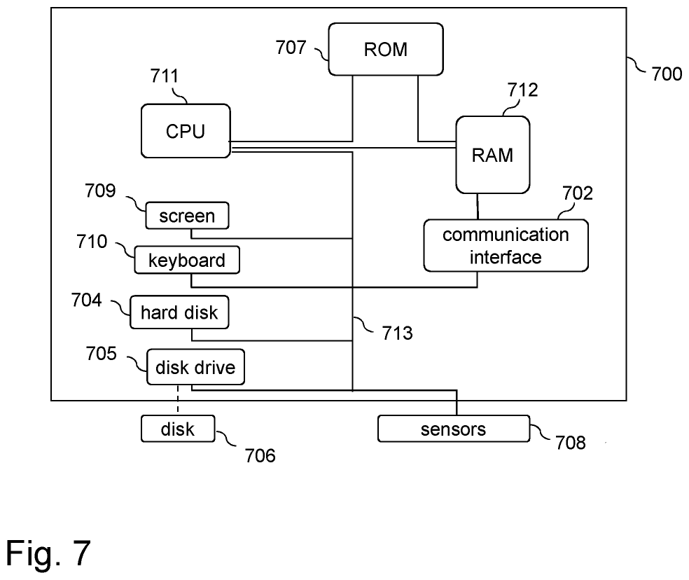

FIG. 7 is a schematic representation of an example of a data processing device configured to implement some embodiments of the present disclosure, in whole or in part.

The data processing device 700 may be a device such as a micro-computer, a workstation, or a light portable device. As illustrated, data processing device 700 comprises a communication bus 713 to which there are preferably connected:
a central processing unit 711, such as a microprocessor, denoted CPU or a GPU (for graphical processing unit),
a read-only memory 707, denoted ROM, for storing computer programs for implementing the disclosure, in whole or in part,
a random access memory 712, denoted RAM, for storing the executable code of methods according to embodiments of the disclosure as well as the registers adapted to record variables and parameters necessary for implementing methods according to embodiments of the disclosure, and
at least one communication interface 702 connected to a communication network for transmitting data to and/or receiving data from a remote device.

Optionally, the data processing device 700 may also include one or several of the following components:
a data storage means 704 such as a hard disk, for storing computer programs for implementing methods according to one or more embodiments of the disclosure,
a disk drive 705 for a disk 706, the disk drive being adapted to read data from the disk 706 or to write data onto this disk, and
a screen 709 for serving as a graphical interface with a user, by means of a keyboard 710 or any other pointing means.

The data processing device 700 may be optionally connected to various peripherals including sensors 708, such as digital cameras and/or LiDARs, each being connected to an input/output card (not shown) so as to supply data to the data processing device 700.

Preferably the communication bus provides communication and interoperability between the various elements included in the data processing device 700 or connected to it. The representation of the bus is not limiting and in particular the central processing unit is operable to communicate instructions to any element of the data processing device 700 directly or by means of another element of the data processing device 700.

The disk 706 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to the invention to be implemented.

The executable code may optionally be stored either in read-only memory 707, on the hard disk 704 or on a removable digital medium such as for example a disk 706 as described previously. According to an optional variant, the executable code of the programs can be received by means of the communication network, via the interface 702, in order to be stored in one of the storage means of the data processing device 700, such as the hard disk 704, before being executed.

The central processing unit 711 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 704 or in the read-only memory 707, are transferred into the random access memory 712, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

Although the present invention has been described herein above with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular, the different features from different embodiments may be interchanged, where appropriate.

Certain of the embodiments of the invention described above may be implemented solely or as a combination of elements of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating point cloud data into an ISOBMFF-based media file, the method comprising:
obtaining a plurality of subsets of the point cloud data;
generating a plurality of input items, each input item describing a subset of point cloud data of the plurality of subsets;
generating a derived item, the derived item comprising descriptive data of a spatial composition of the plurality of input items, the derived item being associated with the plurality of input items by an item reference; and
encapsulating the plurality of input items, the item reference, and the derived item in the media file.

2. The method according to claim 1, wherein the descriptive data further comprise an indicator indicating whether point clouds corresponding to the point cloud data of each subset of point cloud data use a same reference frame.

3. The method according to claim 1, wherein the descriptive data further comprise an indicator indicating whether bounding boxes of point clouds corresponding to the point cloud data described by each of at least two input items of the plurality of input items overlap.

4. The method according to claim 1, wherein the descriptive data further comprise an indicator for describing a three-dimensional array of cells, each input item of the plurality of input items corresponding to one of the cells.

5. The method according to claim 4, wherein the descriptive data further comprise an indicator indicating an order of the plurality of input items in the three-dimensional array of cells.

6. The method according to claim 4, wherein the descriptive data further comprise an indicator for describing a size of at least one of the cells.

7. The method according to claim 4, wherein the size of the cells is determined as a function of bounding boxes of point clouds corresponding to the point cloud data described by each of the plurality of input items.

8. The method according to claim 4, wherein the descriptive data further comprise an indicator indicating that at least one of the cells does not comprise any point defined in the point cloud data.

9. The method according to claim 1, wherein at least one item property is associated with at least one of the input item and/or the derived item for describing at least one spatial operation to be performed on points defined in the point cloud data.

10. The method according to claim 1, wherein the derived item comprises at least one indicator for describing at least one spatial operation to be performed on points defined in the point cloud data.

11. The method according to claim 1, further comprising obtaining the point cloud data and splitting the obtained point cloud data as the plurality of subsets of the point cloud data.

12. A method for parsing an ISOBMFF-based media file encapsulating point cloud data, the method comprising:
obtaining a derived item from the media file, the derived item comprising descriptive data of a spatial composition of a plurality of input items, the derived item being associated with the plurality of input items by an item reference;
obtaining, from the media file, the plurality of input items as a function of the item reference, each input item describing a subset of point cloud data of a plurality of subsets;
obtaining, from the media file, the plurality of subsets of the point cloud data as a function of the plurality of input items; and
generating the point cloud data as a function of the descriptive data, the point cloud data comprising the point cloud data of the plurality of subsets.

13. The method according to claim 12, further comprising determining, as a function of an indicator of the descriptive data, whether point clouds corresponding to the point cloud data of each subset of point cloud data use a same reference frame.

14. The method according to claim 12, further comprising determining, as a function of an indicator of the descriptive data, whether bounding boxes of point clouds corresponding to the point cloud data described by each of at least two input items of the plurality of input items overlap.

15. The method according to claim 12, further comprising determining, as a function of an indicator of the descriptive data, a three-dimensional array of cells, each input item of the plurality of input items corresponding to one of the cells.

16. The method according to claim 15, further comprising determining, as a function of an indicator of the descriptive data, an order of the plurality of input items in the three-dimensional array of cells.

17. The method according to claim 15, further comprising determining, as a function of an indicator of the descriptive data, a size of at least one of the cells.

18. The method according to claim 15, further comprising determining, as a function of an indicator of the descriptive data, that at least one of the cells does not comprise any point defined in the point cloud data.

19. The method according to claim 12, further comprising applying, as a function of at least one item property associated with at least one of the input item and/or the derived item, a spatial operation to points defined in the point cloud data.

20. The method according to claim 12, further comprising applying, as a function of at least one indicator of the derived item, at least one spatial operation to be performed on points defined in the point cloud data.

21. (canceled)

22. A non-transitory computer-readable storage medium storing instructions of a computer program for implementing a method for parsing an ISOBMFF-based media file encapsulating point cloud data, the method comprising:
obtaining a derived item from the media file, the derived item comprising descriptive data of a spatial composition of a plurality of input items, the derived item being associated with the plurality of input items by an item reference;
obtaining, from the media file, the plurality of input items as a function of the item reference, each input item describing a subset of point cloud data of a plurality of subsets;
obtaining, from the media file, the plurality of subsets of the point cloud data as a function of the plurality of input items; and
generating the point cloud data as a function of the descriptive data, the point cloud data comprising the point cloud data of the plurality of subsets.

23. A processing device comprising a processing unit configured for carrying out each step of the method according to claim 1.
